(19) United States
(12) Patent Application Publication
(10) Pub. No.: US 2016/0253286 A1
(43) Pub. Date: Sep. 1, 2016

(54) PROGRAM PROFILER CIRCUIT, PROCESSOR, AND PROGRAM COUNTING METHOD

(71) Applicant: FUJITSU LIMITED, Kawasaki-shi (JP)

(72) Inventor: Takatoshi FUKUDA, Sagamihara (JP)

(73) Assignee: FUJITSU LIMITED, Kawasaki (JP)

(21) Appl. No.: 14/987,087

(22) Filed: Jan. 4, 2016

(30) Foreign Application Priority Data
Feb. 27, 2015 (JP) 2015-038984

(51) Int. Cl. G06F 15/76

(52) U.S. Cl. CPC G06F 15/76

(57) ABSTRACT

A program profiler circuit includes: a stack having a first storage region for stacking, when an instruction to call a subroutine is detected, a head address of the subroutine and for unstacking a lastly stacked head address when a restoration instruction to return to a source from which the subroutine is called is detected; a matching determining unit that has a plurality of second storage regions in which head addresses of subroutines are registered and is configured to output region information indicating a second storage region having registered therein a head address that matches the head address lastly stacked by the stack processing unit; and an accumulator that has a plurality of accumulation regions corresponding to the plurality of second storage regions and is configured to increment with a predetermined value to a value stored in an accumulation region corresponding to the region information output from the matching determining unit.

### CROSS-REFERENCE TO RELATED APPLICATION

This application is based upon and claims the benefit of priority of the prior Japanese Patent Application No. 2015-038984, filed on Feb. 27, 2015, the entire contents of which are incorporated herein by reference.

### FIELD

The embodiments discussed herein are related to a program profiler circuit, a processor, and a program counting method.

### BACKGROUND

For example, as a tool for analyzing the performance of a program executed by a processor such as a central processing unit (CPU), a profiler device configured to measure execution times of various events executed by the program or the numbers of executions of the events is known. The profiler device of this type includes an index table that receives values (addresses), generated by the processor, of a program counter and outputs function numbers indicating functions (subroutines) corresponding to the values of the program counter. Then, the profiler device measures execution times of the functions based on time periods for continuously outputting the function numbers from the index table and measures the numbers of executions of the functions based on changes in the function numbers. The execution times and the numbers of the executions that are measured by the profiler device are stored in a memory, and the performance of the program is analyzed based on the information stored in the memory (refer to, for example, Japanese Laid-open Patent Publication No. 2004-348635).

In addition, in order to write information such as the number of occurrences of a specific instruction or the like in the memory, the profiler device writes information having a high degree of importance over information having a low degree of importance and stored in the memory and thereby suppresses insufficiency of a region in which the information is to be written (refer to, for example, Japanese Laid-open Patent Publication No. 2002-342125).

If an address size of a storage region for storing the program to be analyzed is larger than an address size of the index table in the aforementioned profiler device, the index table may convert a value of the program counter into an erroneous function number. It is, therefore, difficult for the profiler device to measure execution times of the functions included in the program stored in the storage region that has the address size larger than that of the index table.

According to an aspect, a program profiler circuit, a processor, and a program counting method that are disclosed herein aim to measure execution times of subroutines included in a program regardless of the size of the program.

### SUMMARY

According to an aspect of the invention, an program profiler circuit includes: a stack having a first storage region for stacking, when an instruction to call a subroutine is detected, a head address of the subroutine and for unstacking a lastly stacked head address when a restoration instruction to return to a source from which the subroutine is called is detected; a matching determining unit that has a plurality of second storage regions in which head addresses of subroutines are registered and is configured to output region information indicating a second storage region having registered therein a head address that matches the head address lastly stacked by the stack processing unit; and an accumulator that has a plurality of accumulation regions corresponding to the plurality of second storage regions and is configured to increment with a predetermined value to a value stored in an accumulation region corresponding to the region information output from the matching determining unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is diagram illustrating a first embodiment of a program profiler circuit, a processor, and a program counting method;

FIG. 2 is a diagram illustrating a second embodiment of the program profiler circuit, the processor, and the program counting method;

FIG. 3 is a diagram illustrating an example of a CPU illustrated in FIG. 2;

FIG. 4 is a diagram illustrating an example of a stack processing unit illustrated in FIG. 2;

FIG. 5 is a diagram illustrating a program that is executed by the CPU illustrated in FIG. 2 and is to be evaluated;

FIG. 6 is a diagram illustrating an example of data registered in a CAM illustrated in FIG. 2;

FIG. 7 is a diagram illustrating an example of a RAM illustrated in FIG. 2;

FIG. 8 is a diagram illustrating an example of operations of a program profiler circuit illustrated in FIG. 2 in an evaluation mode and a measurement mode;

FIG. 9 is a diagram illustrating an example of operations of the program profiler circuit illustrated in FIG. 2 in the measurement mode;

FIG. 10 is a diagram illustrating the example of operations (continued from FIG. 9) of the program profiler circuit illustrated in FIG. 2 in the measurement mode; and

FIG. 11 is a diagram illustrating a third embodiment of the program profiler circuit, the processor, and the program counting method.

### DESCRIPTION OF EMBODIMENTS

Hereinafter, embodiments are described with reference to the accompanying drawings. For signal lines through which signals are transmitted, reference symbols that are the same as the names of the signals are used. A signal with “/” at the top of a signal name indicates a negative logical level.

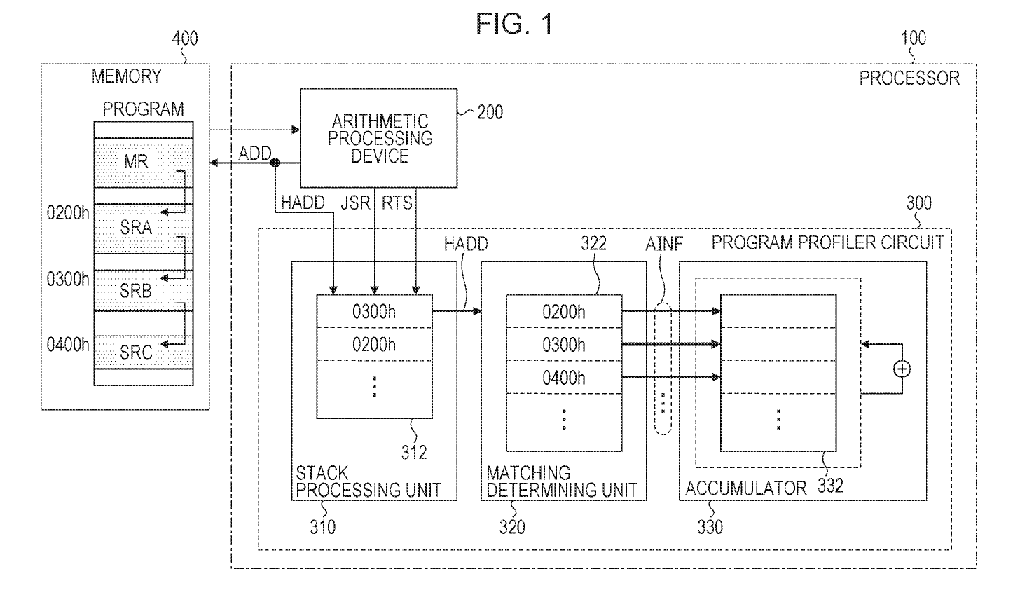

FIG. 1 illustrates a first embodiment of a program profiler circuit, a processor, and a program counting method. A processor 100 illustrated in FIG. 1 includes an arithmetic processing device 200 and a program profiler circuit 300. The arithmetic processing device 200 executes calculation based on a fetched instruction. The program profiler circuit 300 measures execution times of multiple subroutines SR (SRA, SRB, and SRC) included in a program.

The arithmetic processing device 200 detects an instruction to call a subroutine SR, generates call information JSR based on the detection of the call instruction, and outputs a head address HADD of the subroutine SR to be called. In addition, the arithmetic processing device 200 detects a restoration instruction to cause the program to return to a source from which the subroutine SR is called, and the arithmetic processing device 200 generates restoration information RTS based on the detection of the restoration instruction.

The arithmetic processing device 200 outputs an address ADD to a memory 400, fetches an instruction included in the program stored in the memory 400, and executes the fetched instruction. In the example illustrated in FIG. 1, the subroutine SRA is called based on a call instruction described in a main routine MR, and the subroutine SRB is called based on a call instruction described in the subroutine SRA. The subroutine SRC is called based on a call instruction described in the subroutine SRB. A head address at which the subroutine SRA is stored in the memory is “0200h”, and a head address at which the subroutine SRB is stored in the memory is “0300h”. A head address at which the subroutine SRC is stored in the memory is “0400h”. The ends “h” of the addresses indicate that the addresses are hexadecimal addresses.

The program profiler circuit 300 includes a stack processing unit 310, a matching determining unit 320, and an accumulator 330. The stack processing unit 310 includes a storage region 312 for sequentially holding the head addresses HADD of the subroutines and stacks the head addresses HADD output from the arithmetic processing device 200 in the storage region 312 based on the call information JSR. The stack processing unit 310 outputs a lastly stacked head address HADD. The stack processing unit 310 unstacks the lastly stacked head address HADD from the storage region 312 based on the restoration information RTS. In this manner, the stack processing unit 310 operates in a so-called first-in-last-out scheme.

The stack processing unit 310 executes the operation of stacking a head address HADD based on the call information JSR generated by the arithmetic processing device 200 upon the detection of a call instruction and executes the operation of unstacking a head address HADD based on the restoration information RTS generated by the arithmetic processing device 200 upon the detection of a restoration instruction. The call information JSR and the restoration information RTS exist in a conventional processing device. Thus, the stacking operation and unstacking operation of the stack processing unit 310 may be achieved by adding, to the arithmetic processing device 200, signal lines through which the call information JSR and the restoration information RTS are transmitted to the external without the addition of a new circuit to the arithmetic processing device 200.

FIG. 1 illustrates the state of the stack processing unit 310 when the subroutine SRB is executed. The stack processing unit 310 outputs the lastly stacked head address “0300h” held by the storage region 312 to the matching determining unit 320. In addition, the stack processing unit 310 holds, in the storage region 312, the head address “0200h” of the subroutine SRA executed before the subroutine SRB is called. The stack processing unit 310 outputs the head address “0300h” until receiving the restoration information RTS corresponding to a restoration instruction to cause the program to return from the subroutine SRB to the subroutine SRA. Then, the stack processing unit 310 receives the restoration information RTS corresponding to the restoration instruction to cause the program to return from the subroutine SRB to the subroutine SRA, stacks the head address “0300h” in the storage region 312 based on the reception of the restoration information RTS, and outputs the head address “0200h”.

The number (storage capacity of the stack processing unit 310) of head addresses able to be held by the stack processing unit 310 is set based on the maximum number of nests of the subroutines described in the program. For example, if the maximum number of the nests is “16”, it is sufficient if the stack processing unit 310 has 16 regions for holding head addresses.

The matching determining unit 320 includes multiple storage regions 322 in which the head addresses of the subroutines are registered in advance. In FIG. 1, the head addresses “0200h”, “0300h”, and “0400h” of the subroutines SRA, SRB, and SRC are stored in three storage regions 322, respectively. The storage regions 322 in which the head addresses of the subroutines SRA, SRB, and SRC are registered may not be continuous and may be distributed. The matching determining unit 320 compares a head address HADD output from the stack processing unit 310 with the head addresses registered in the storage regions 322. Then, during the time when the head address HADD output from the stack processing unit 310 matches any of the head addresses registered in the storage regions 322, the matching determining unit 320 outputs region information AINF indicating a storage region 322 in which the matched head address is registered.

In the example illustrated in FIG. 1, the matching determining unit 320 asserts a signal line (indicated by a solid line) corresponding to the storage region 322 in which the head address “0300h” output from the stack processing unit 310 is registered, and the matching determining unit 320 maintains negated signal lines corresponding to the other storage regions 322. Thus, the region information AINF that indicates the storage region 322 in which the address “0300h” is registered is output to the accumulator 330. The region information AINF indicates a subroutine SR that is being executed by the arithmetic processing device 200. The matching determining unit 320 may output, to the accumulator 330 through a common signal line, region information (such as an address) indicating the position of the storage region 322 in which the address “0300h” is registered.

The number of storage regions 322 included in the matching determining unit 320 is set based on the maximum number of subroutines described in the program. Thus, the number of the storage regions 322 included in the matching determining unit 320 may be reduced, compared with a case where storage regions 322 that correspond to all addresses of the program to be measured by the program profiler circuit 300 are included in the matching determining unit 320. In other words, by installing the stack processing unit 310, only the head addresses HADD of the subroutines may be supplied to the matching determining unit 320, instead of the supply of all the addresses of the program to be measured, and the size of a circuit of the matching determining unit 320 may be reduced.

The accumulator 330 includes multiple accumulation regions 332 corresponding to the multiple storage regions 322 of the matching determining unit 320, respectively. Specifically, the number of the accumulation regions 332 included in the accumulator 330 is set based on the maximum number of subroutines described in the program, like the matching determining unit 320. During the time when the region information AINF is output from the matching determining unit 320, the accumulator 330 repeats an accumulation process of adding a predetermined value to a value stored in an accumulation region 332 corresponding to the region information AINF and storing a value obtained by the addition in the accumulation region 332 corresponding to the region information AINF. Thus, accumulated values that correspond to time periods for which the subroutines SR are executed are stored in the accumulation regions 332 corresponding to the subroutines SR. The execution times of the subroutines SR are indicated by products of the accumulated values stored in the accumulation regions 332 and a cycle of the accumulation process of adding the predetermined value to the values stored in the accumulation regions 332 and storing values obtained by the addition in the accumulation regions 332. In other words, the accumulated values stored in the accumulation regions 332 indicate the execution times of the subroutines SR. Specifically, a program counting method of measuring the execution times of the subroutines SR is achieved by the program profiler circuit 300.

For example, the process of adding the predetermined value and storing values in the accumulation regions 332 is executed for each cycle of a clock to be used to cause the program profiler circuit 300 to operate. In this case, in order to execute the addition process without an erroneous operation of the accumulator 330, it is preferable that the frequency of the clock to be used to cause the program profiler circuit 300 to operate be lower than the frequency of a clock to be used to cause the arithmetic processing device 200 to operate. If the process of adding the predetermined value and storing values in the accumulation regions 332 is executed for each cycle of the clock, the execution times of the subroutines SR are indicated by products of the accumulated values stored in the accumulation regions 332 and the cycle of the clock.

In the embodiment illustrated in FIG. 1, the stack processing unit 310 stacks a head address HADD of a subroutine SR based on the call information JSR and keeps on outputting the stacked head address HADD until receiving the next call information JSR or restoration information RTS. In addition, the stack processing unit 310 unstacks a lastly stacked head address HADD based on the restoration information RTS. Then, the stack processing unit 310 keeps on outputting the lastly stacked head address HADD among the stacked head addresses HADD until receiving the next call information JSR or restoration information RTS. Thus, a time period for which the stack processing unit 310 outputs a head address HADD may match a time period for which a subroutine SR corresponding to the head address HADD is executed. As a result, the execution times of the subroutines included in the program may be measured regardless of the size of the program.

In addition, the stacking operation and unstacking operation of the stack processing unit 310 may be achieved by using the call information JSR and restoration information RTS generated by the arithmetic processing device 200 without the addition of a new circuit to the arithmetic processing device 200.

Furthermore, the execution times of the subroutines are measured by the program profiler circuit 300 without the insertion of an intercept process routine for measurement or the like in the program. Thus, the execution times of the subroutines may be measured without a reduction in the efficiency of executing the program.

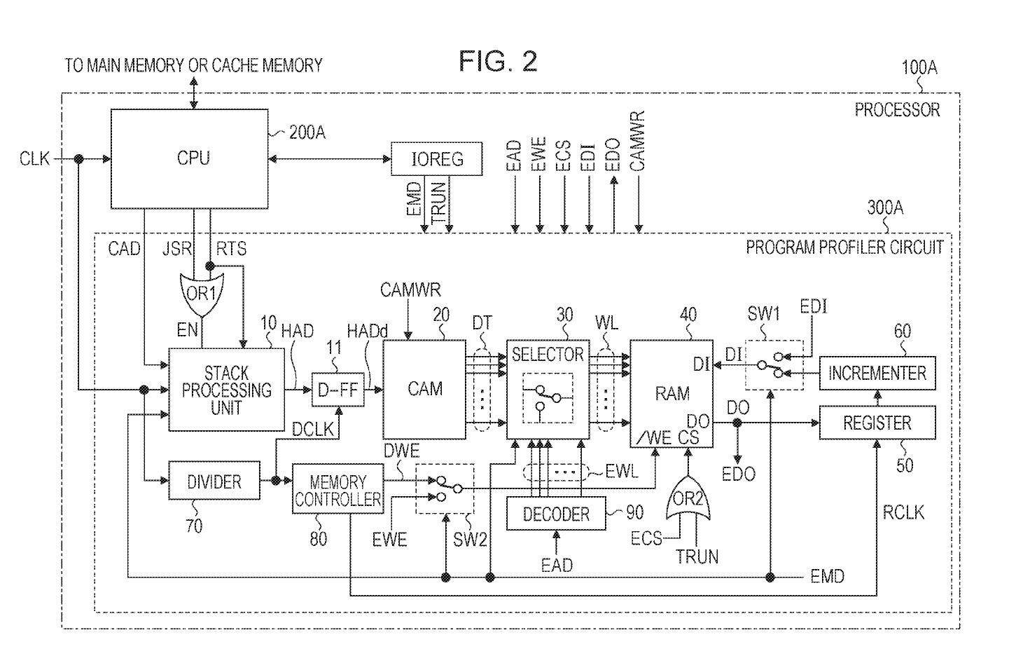

FIG. 2 illustrates a second embodiment of the program profiler circuit, the processor, and the program counting method. A processor 100A (for example, a semiconductor chip) illustrated in FIG. 2 includes a CPU 200A, a program profiler circuit 300A, and a register IOREG. If the processor 100A includes multiple CPUs 200A, the processor 100A includes program profiler circuits 300A for the CPUs 200A. The processor 100A may include a direct memory access controller (DMAC) and peripheral circuits such as a timer and an input and output circuit.

The CPU 200A operates in synchronization with a clock CLK and executes programs stored in a memory such as a main memory or a cache memory. The programs to be executed by the CPU 200A include an operating system, a program to be executed to measure execution times of subroutines and to be evaluated, and an evaluation program. The evaluation program is executed to control the program profiler circuit 300A and measure the execution times of the subroutines (functions) included in a program (application program or the like) to be evaluated. The cache memory may be installed in the processor 100A. The CPU 200A is an example of an arithmetic processing device.

The processor 100A has a function of setting predetermined information in the register IOREG based on the evaluation program executed by the CPU 200A. In addition, the processor 100A has a function of generating an address EAD, a write enable signal EWE, a chip select signal ECS, a data input signal EDI, and a control signal CAMWR based on the evaluation program executed by the CPU 200A. In addition, the processor 100A has a function of receiving a data output signal EDO from the program profiler circuit 300A based on the evaluation program executed by the CPU 200A. The register IOREG outputs a mode signal EMD and a task run signal TRUN based on the set information.

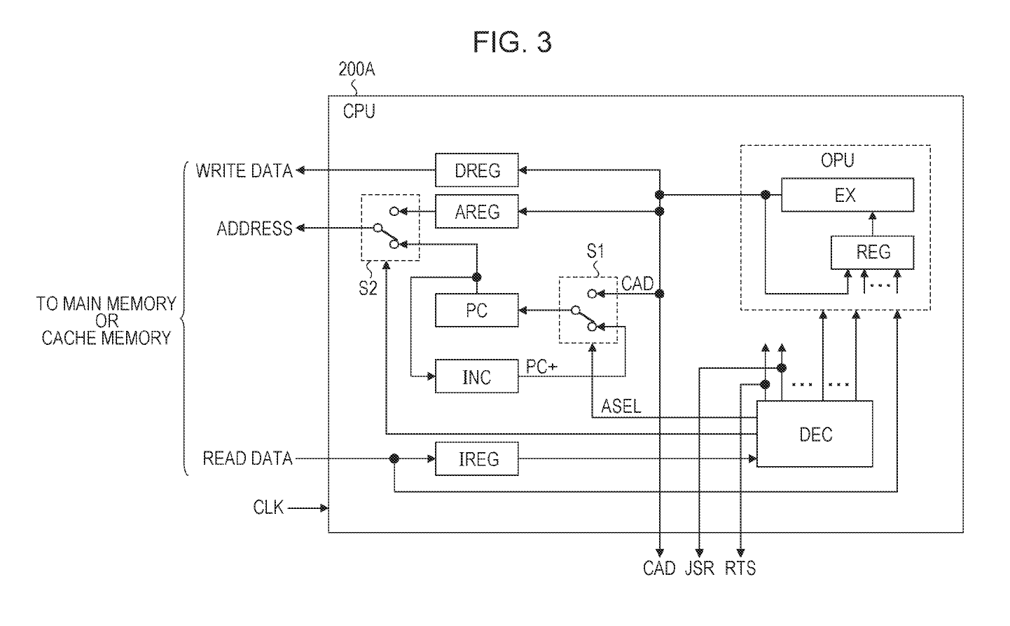

The CPU 200A decodes a jump subroutine (JSR) instruction to call a subroutine and outputs, based on the decoding of the JSR instruction, a head address CAD of the subroutine and call information JSR indicating the execution of the JSR instruction to the program profiler circuit 300A. The JSR instruction is an example of a call instruction. In addition, the CPU 200A decodes a return subroutine (RTS) instruction to cause the program to return to a source from which a subroutine is called, and the CPU 200A outputs, based on the decoding of the RTS instruction, restoration information RTS indicating the execution of the RTS instruction to the program profiler circuit 300A. The RTS instruction is an example of a restoration instruction. An example of the CPU 200A is illustrated in FIG. 3. The number of bits of the address CAD is not limited, but is assumed to be 16 for clarification of the description.

The program profiler circuit 300A includes a stack processing unit 10, a flip-flop 11, a content addressable memory (CAM) 20, a selector 30, and a random access memory (RAM) 40. The program profiler circuit 300A also includes a register 50, an incrementer 60, a divider 70, a memory controller 80, a decoder 90, switches SW1 and SW2, and OR circuits OR1 and OR2.

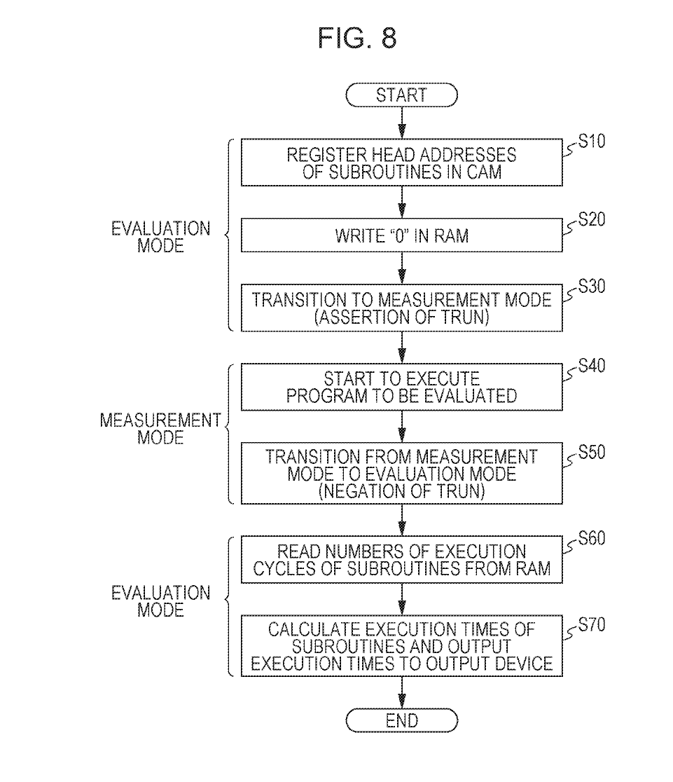

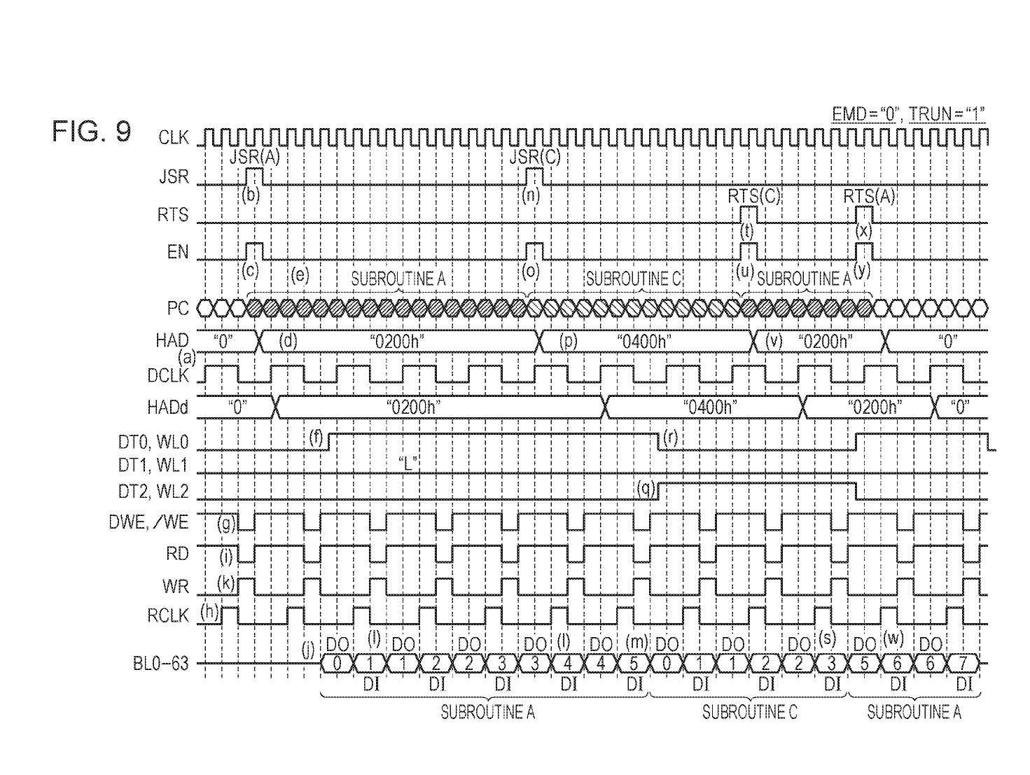

When receiving the mode signal EMD of a first logical level, the program profiler circuit 300A transitions to a measurement mode in which the program profiler circuit 300A measures the execution times of the subroutines included in the program (application program or the like) to be evaluated. When receiving the mode signal EMD of a second logical level different from the first logical level, the program profiler circuit 300A initializes the CAM 20 and the RAM 40 and transitions to an evaluation mode in which the program profiler circuit 300A reads, from the RAM 40, information indicating the execution times measured in the measurement mode. Outlines of the evaluation mode and measurement mode are illustrated in FIG. 8, and an example of operations of the program profiler circuit 300A in the measurement mode is illustrated in FIG. 9.

The OR circuit OR1 outputs an enable signal EN during the time when the OR circuit OR1 receives the call information JSR or the restoration information RTS from the CPU 200A. The OR circuit OR2 outputs a task run signal TRUN or a chip select signal ECS to a chip select terminal CS of the RAM 40. The task run signal TRUN is asserted when the program to be evaluated is to be executed by the CPU 200A in the measurement mode. The chip select signal ECS is generated by the processor 100A based on the execution of the evaluation program.

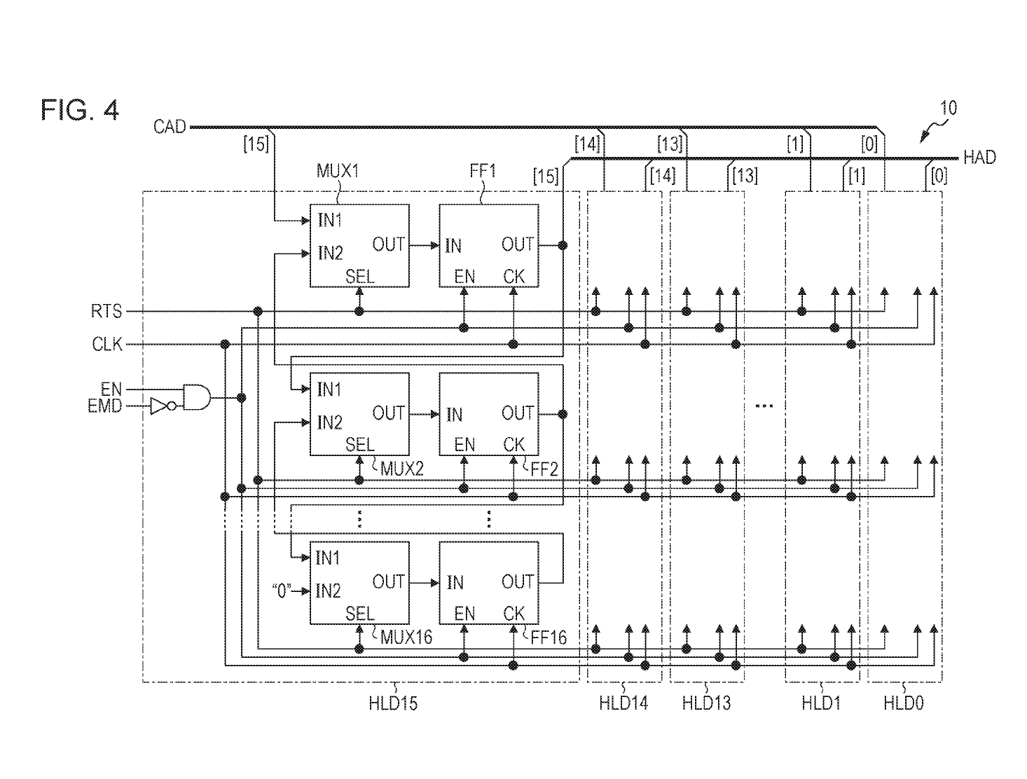

The stack processing unit 10 includes storage regions (flip-flops FF1 to FF16 illustrated in FIG. 4) for stacking head addresses CAD output from the CPU 200A. When the stack processing unit 10 receives the enable signal EN and does not receive the restoration information RTS (or receives the call information JSR) in the measurement mode, the stack processing unit 10 stacks a head address CAD in a storage region. In addition, when the stack processing unit 10 receives the enable signal EN and the restoration information RTS in the measurement mode, the stack processing unit 10 unstacks a head address CAD from a storage region. The stack processing unit 10 has a function of outputting, as an address HAD, a lastly stacked address CAD among the stacked addresses CAD. An example of the stack processing unit 10 is illustrated in FIG. 4.

The flip-flop 11 (D-FF) latches the address HAD received from the stack processing unit 10 in synchronization with a divided clock DCLK and outputs the latched address as an address HADd to the CAM 20.

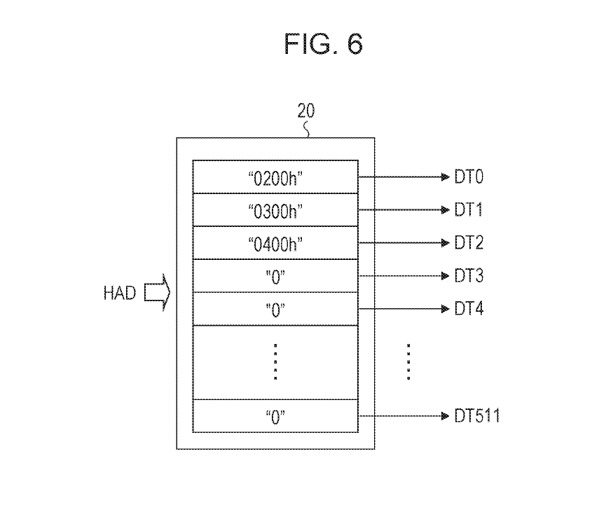

The CAM 20 has multiple storage regions in which the head addresses of the subroutines are registered in advance. An example of the state of the CAM 20 in which the head addresses are already registered is illustrated in FIG. 6. During the time when the address HADd received from the flip-flop 11 matches any of the addresses registered in the storage regions, the CAM 20 asserts a data line DT corresponding to a storage region holding a value of the address HADd and negates other data lines DT. It is sufficient if the CAM 20 has storage regions whose number corresponds to the maximum number of subroutines described in the program. Thus, the size of a circuit of the CAM 20 may be reduced, compared with a case where storage regions corresponding to all addresses of the program to be evaluated are included in the RAM. The CAM 20 is an example of a matching determining unit.

The CAM 20 registers, in the storage regions based on a control signal CAMWR generated by the processor 100A, data indicating the head addresses of the subroutines included in the program executed by the CPU 200A. The control signal CAMWR includes addresses indicating the storage regions of the CAM 20, data signals indicating logical levels of the data to be written in the storage regions, and a signal that controls the writing of the data. The data is written in the CAM 20 based on the control signal CAMWR before the measurement of the execution times of the subroutines is started by the evaluation program executed by the CPU 200A.

The decoder 90 decodes the address EAD generated within the processor 100A in the evaluation mode and asserts any of word line signals EWL that is indicated by the address EAD. The selector 30 transfers the word line signal EWL received from the decoder 90 through a word line WL to the RAM 40 in the evaluation mode. The selector 30 transfers the data signals DT received from the CAM 20 through word lines WL to the RAM 40 in the measurement mode.

The RAM 40 executes a writing operation when receiving a high-level signal by the chip select terminal CS and receiving a low-level signal by a write enable terminal/WE. In the writing operation, the RAM 40 writes data received by data input terminals DI in memory cells connected to the word line WL that is at a high level and through which the RAM 40 receives the signal through the selector 30. The data input terminals DI receive the data input signal EDI through the switch SW1 in the evaluation mode and receive a value output from the incrementer 60 through the switch SW1 in the measurement mode. For example, the data input terminals DI is 32-bit terminals. FIG. 2 illustrates the state of the switch SW1 in the measurement mode.

The RAM 40 executes a reading operation when receiving a high-level signal by the chip select terminal CS and receiving a high-level signal by the write enable terminal/WE. In the reading operation, the RAM 40 outputs, from data output terminals DO, data read from memory cells connected to the word line WL at the high level. For example, the data output terminals DO are 32-bit terminals. The RAM 40 is an example of a storage unit that reads, based on a read request, values held by memory cells MC connected to the word line WL at the high level and writes, based on a write request, values in the memory cell MC connected to the word line WL at the high level.

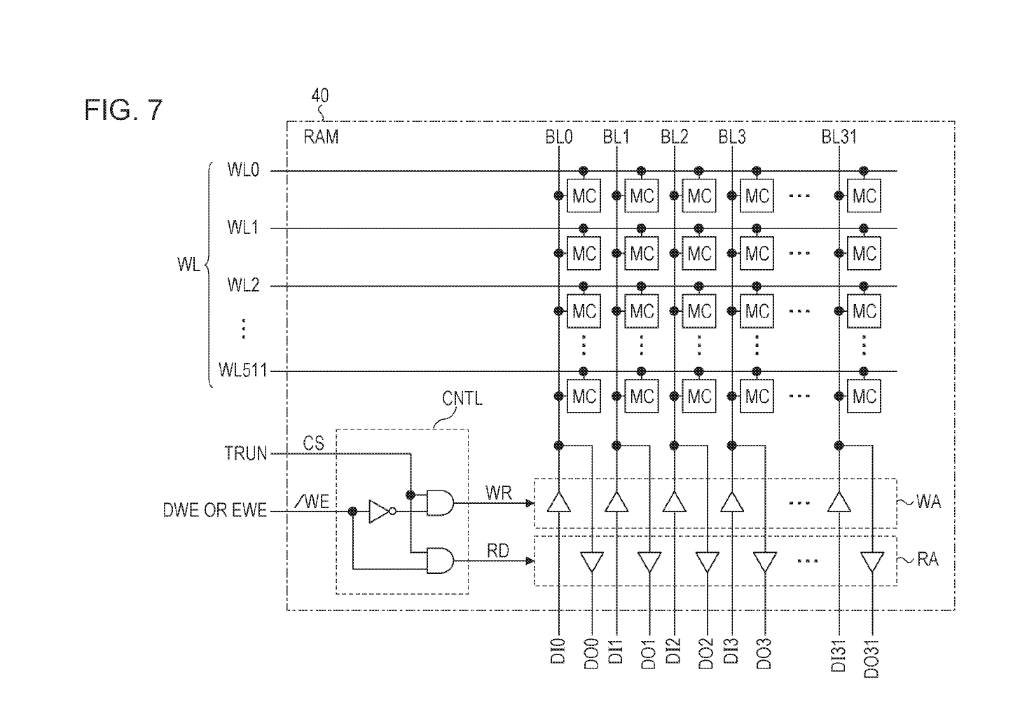

Logical levels of the chip select terminal CS, write enable terminal/WE, and word lines WL when the RAM 40 operates depend on a circuit of the RAM 40 and are not limited to the aforementioned levels. An example of the RAM 40 is illustrated in FIG. 7. The program profiler circuit 300A may include, instead of the RAM 40, another memory (ferroelectric memory or the like) that executes the writing operation in cycles that are equal to or close to cycles of the reading operation.

The register 50 holds, in synchronization with a clock RCLK, the data output from the data output terminals DO of the RAM 40 and outputs the held data to the incrementer 60. The register 50 is an example of a holder that holds a value read from the RAM 40.

The incrementer 60 receives the data output from the register 50, increments values of the received data by 1, and outputs the incremented data to the RAM 40 through data input terminals DI. The incrementer 60 is an example of an adder that adds a predetermined value “1” to values held by the register 50 and outputs values obtained by the addition to the RAM 40. The RAM 40, the register 50, and the incrementer 60 are an example of an accumulator (counter) that repeats a process of adding the predetermined value to a value stored in an accumulation region corresponding to region information during the time when the CAM 20 outputs the region information.

The divider 70 divides the frequency of the clock CLK and generates the divided clock DCLK. The divider 70 may be installed outside the program profiler circuit 300A. A clock that is different from the clock CLK may be supplied to the processor 100A from outside the processor 100A, while the divider 70 may not be installed in the program profiler circuit 300A. It is sufficient if the frequency of the divided clock DCLK may be a frequency that enables the reading operation and writing operation of the RAM 40 to be executed within one cycle of the divided clock DCLK.

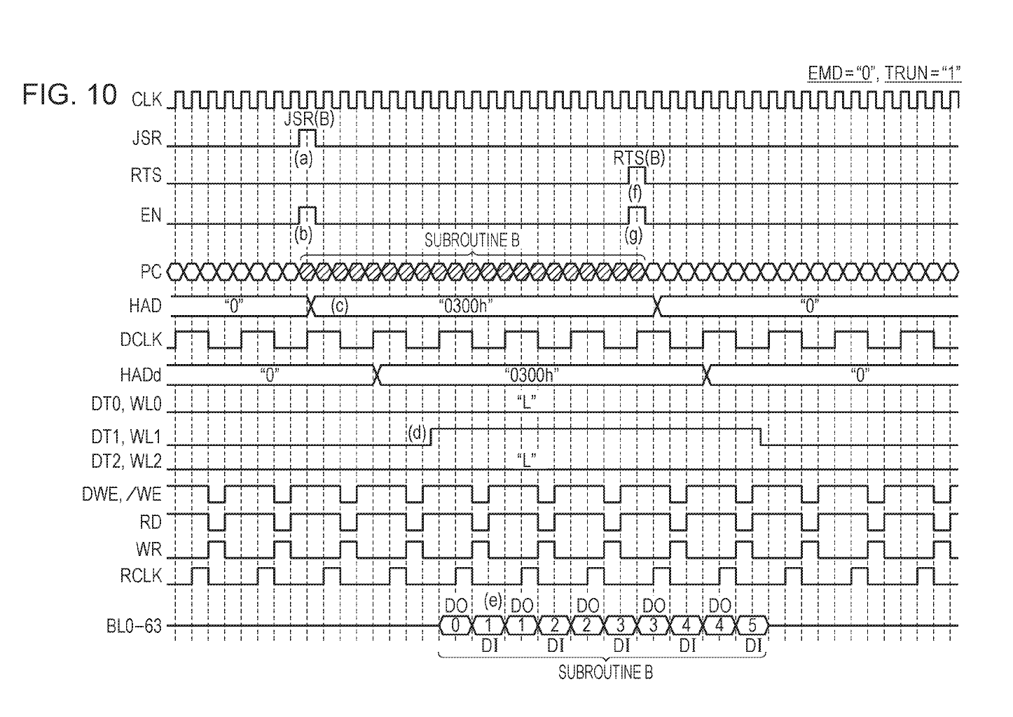

The memory controller 80 generates the write enable signal DWE and the clock RCLK in synchronization with the divided clock DCLK. When the write enable signal DWE is at a high level, the write enable signal DWE indicates the read request to be transmitted to the RAM 40. When the write enable signal DWE is at a low level, the write enable signal DWE indicates the write request to be transmitted to the RAM 40. Examples of waveforms of the write enable signal DWE and clock RCLK generated by the memory controller 80 are illustrated in FIGS. 9 and 10.

The switch SW2 transfers the write enable signal EWE generated by the processor 100A to the write enable terminal/WE of the RAM 40 in the evaluation mode. The switch SW2 transfers the write enable signal DWE received from the memory controller 80 to the write enable terminal/WE of the RAM 40 in the measurement mode. FIG. 2 illustrates the state of the switch SW2 in the measurement mode.

FIG. 3 illustrates an example of the CPU 200A illustrated in FIG. 2. FIG. 3 illustrates a core part of the CPU 200A. The CPU 200A includes an operating unit OPU, a data register DREG, an address register AREG, a program counter PC, an incrementer INC, an instruction register IREG, an instruction decoder DEC, and selectors S1 and S2. The operating unit OPU includes a register file REG and an executor EX.

The program counter PC outputs an address received from the selector S1 to the incrementer INC and the selector S2. The incrementer INC increments the address received from the program counter PC and outputs the incremented address PC+ to the selector S1.

If a selection signal ASEL output from the instruction decoder DEC indicates that instructions are fetched in order of addresses, the selector S1 selects the address PC+ received from the incrementer INC. If the selection signal ASEL indicates the execution of an address change instruction to change an address to another address other than the address PC+, the selector S1 selects an address CAD received from the operating unit OPU. In this case, the address change instruction is the JSR instruction, the RTS instruction, a branch instruction, a jump instruction, or the like. Then, the selector S1 outputs the selected address to the program counter PC. If the instructions are to be sequentially fetched, the selector S2 selects an address output from the program counter PC. If the address change instruction is executed and the CPU 200A outputs or receives data based on a load instruction, a store instruction, or the like, the selector S2 selects an address output from the address register AREG. Then, the selector S2 outputs the selected address to the memory such as the main memory or the cache memory.

In order for the CPU 200A to fetch an instruction, the instruction is read as read data from the memory based on the address output from the selector S2 and is stored in the instruction register IREG. If the CPU 200A executes the load instruction, data is read from the memory based on the address output from the selector S2 and is stored in the register file REG. If the CPU 200A executes the store instruction, data output from the data register DREG is written as write data in the memory based on the address output from the selector S2.

The instruction register IREG has multiple regions for holding instructions received from the memory and sequentially outputs the held instructions to the instruction decoder DEC. The instruction decoder DEC decodes the instructions received from the instruction register IREG and generates, based on the results of the decoding, multiple control signals that control operations of the operating unit OPU, selectors S1 and S2, and the like. The multiple control signals include the call information JSR, the restoration information RTS, and the selection signal ASEL.

The data register DREG has multiple regions for holding data output from the operating unit OPU upon the execution of the store instruction. The address register AREG has multiple regions for holding addresses output from the operating unit OPU upon the execution of the address change instruction, load instruction, or store instruction.

The register file REG has multiple registers for holding data read from the memory or data output from the executor EX. The register file REG outputs, to the executor EX, data held by at least any of the multiple registers of the register file REG based on the control signals received from the instruction decoder DEC.

The executor EX executes calculation in accordance with the instructions decoded by the instruction decoder DEC and outputs results of the calculation to the register file REG, the decoder register DREG, the address register AREG, or the selector S1.

FIG. 4 illustrates an example of the stack processing unit 10 illustrated in FIG. 2. The stack processing unit 10 includes multiple holders HLD (HLD0 to HLD15) for stacking 16-bit addresses CAD [0:15] received from the CPU 200A for bits. The number of holders HLD is equal to the number of bits of each of the held addresses CAD [0:15] and is 16 in the example illustrated in FIG. 4. The configurations of the holders HLD0 to HLD15 are the same as each other, and the configuration of the holder HLD15 is described below.

The holder HLD15 includes 16 flip-flops FF (FF1 to FF16) that hold a 16th-bit [15] of the address CAD. The flip-flops FF1 to FF16 are an example of a first storage region. The holder HLD15 includes 16 multiplexers MUX (MUX1 to MUX16) configured to stack or unstack the address CAD bit [15] in or from the adjacent flip-flops FF. In FIG. 4, an illustration of the flip-flops FF3 to FF15 and the multiplexers MUX3 to MUX15 is omitted.

The number of flip-flops FF and the number of multiplexers MUX are set to numbers that are equal to or larger than the number of nests (layers) of the subroutines included in the program. In other words, the program profiler circuit 300A that includes the stack processing unit 10 illustrated in FIG. 4 may measure execution times of the subroutines that include 16 nests or less and are included in the program.

The flip-flops FF operate in synchronization with the clock CLK received by clock terminals CK during the time when the enable signal EN is at the high level in the measurement mode in which the mode signal EMD is negated to the low level. The flip-flops FF latch values of the address CAD [15] received by input terminals IN in synchronization with the clock CLK and output the latched values from output terminals OUT. The output terminal OUT of the flip-flop FF1 is connected to an input terminal IN1 of the multiplexer MUX2 and an address line through which an address HAD [15] among 16-bit addresses HAD [0:15] is transmitted.

The output terminals OUT of the flip-flops FF2 to FF16 are connected to input terminals IN2 of the multiplexers MUX1 to MUX15 corresponding to the flip-flops FF1 to FF15 each located at the next higher stage (upper side of FIG. 4), respectively. The output terminals OUT of the flip-flops FF2 to FF15 are connected to input terminals IN1 of the multiplexers MUX3 to MUX16 corresponding to the flip-flops FF3 to FF16 each located at the next lower stage (lower side of FIG. 4).

The multiplexers MUX1 to MUX16 output, from output terminals OUT, the address CAD [15] received by the input terminals IN1 during the time when the multiplexers MUX1 to MUX16 receive the low-level restoration information RTS by selection terminals SEL. In addition, the multiplexers MUX1 to MUX16 output, from the output terminals OUT, the address CAD [15] received by the input terminals IN2 during the time when the multiplexers MUX1 to MUX16 receive the high-level restoration information RTS by the selection terminals SEL. The output terminals OUT of the multiplexers MUX1 to MUX16 are connected to the input terminals IN of the flip-flops FF1 to FF16, respectively. The multiplexer MUX1 receives the address CAD [15] from the CPU 200A by the input terminal IN1. In FIG. 4, a logical value “0” is supplied to the input terminal IN2 of the multiplexer MUX16. A logical value “1” may be supplied to the input terminal IN2 of the multiplexer MUX16.

When receiving the high-level enable signal EN and the low-level restoration information RTS, the holder HLD15 executes the stacking operation of holding the address CAD [15] received from the CPU 200A. The high-level enable signal EN and the low-level restoration information RTS indicate the execution of the JSR instruction. In the stacking operation, the address CAD [15] held by the flip-flops FF1 to FF15 is transferred to the flip-flops FF2 to FF16 each located at the next lower stage. The holder HLD15 outputs the newly stacked address CAD [15] as the address HAD [15].

When receiving the high-level enable signal EN and the high-level restoration information RTS, the holder HLD15 executes the unstacking operation of transferring the address CAD [15] held by the flip-flops FF to the flip-flops FF each located at the next higher stage. The high-level enable signal EN and the high-level restoration information RTS indicate the execution of the RTS instruction. Then, the holder HLD15 outputs, as the address HAD [15], the address CAD [15] transferred from the flip-flop FF2 to the flip-flop FF1. Operations of the holders HLD1 to HLD14 are the same as the operations of the holder HLD15, except for the fact that bits of the addresses CAD held by the holders HLD1 to HLD14 are different from bits of the address CAD held by the holder HLD15.

In the evaluation mode in which the mode signal EMD is asserted to the high level, the flip-flops FF do not execute the operation of latching data and the stack processing unit 10 stops the operations of stacking and unstacking the addresses CAD.

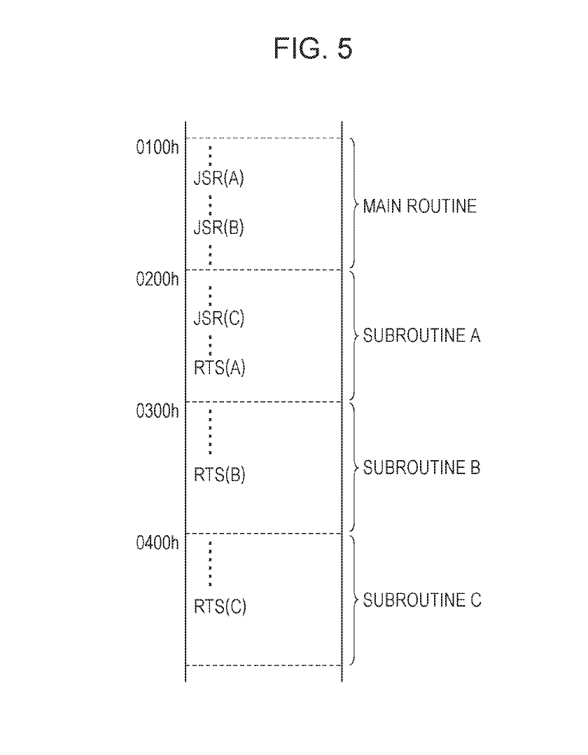

FIG. 5 illustrates an example of the program to be evaluated and executed by the CPU 200A illustrated in FIG. 2. The program to be evaluated includes subroutines whose execution times are measured by the program profiler circuit 300A. The program illustrated in FIG. 5 and to be evaluated is stored in the main memory or the like.

The program to be evaluated includes a main routine including an instruction JSR(A) to call a subroutine A and an instruction JSR(B) to call a subroutine B and includes the subroutines A and B and a subroutine C. The subroutine A includes an instruction JSR(C) to call the subroutine C. For example, the main routine is stored from an address “0100h” of the main memory, and the subroutines A, B, and C are stored from addresses “0200h”, “0300h”, and “0400h” of the main memory.

FIG. 6 illustrates an example of data registered in the CAM 20 illustrated in FIG. 2. The data is registered in the CAM 20 by the evaluation program executed by the CPU 200A in the evaluation mode.

The evaluation program writes the head address “0200h” of the subroutine A illustrated in FIG. 5 in a storage region corresponding to a data line DT0 of the CAM 20. The evaluation program writes the head address “0300h” of the subroutine B illustrated in FIG. 5 in a storage region corresponding to a data line DT1 of the CAM 20. The evaluation program writes the head address “0400h” of the subroutine C illustrated in FIG. 5 in a storage region corresponding to a data line DT2 of the CAM 20. The evaluation program writes “0” in storage regions corresponding to other data lines DT3 to DT511. In the storage regions corresponding to the other data lines DT3 to DT511, a value of an address of the main memory at which the program to be evaluated is not stored may be written.

The CAM 20 compares a value of the address HAD received from the stack processing unit 10 with the address values held in the multiple storage regions. If the value of the address HAD matches any of the address values held in the multiple storage regions, the CAM 20 asserts, to the high level, a data line DT corresponding to a storage region holding the matched address value. As illustrated in FIGS. 9 and 10, during the time when any of the subroutines A, B, and C is executed, the stack processing unit 10 outputs a head address of the executed subroutine as the address HAD. Thus, time periods for which the data lines DT are at the high level indicate time periods for which the subroutines are executed.

The CAM 20 sets the data line DT0 to the high level during the time when the CAM 20 receives the address HAD “0200h” from the stack processing unit 10. The CAM 20 sets the data line DT1 to the high level during the time when the CAM 20 receives the address HAD “0300h” from the stack processing unit 10. The CAM 20 sets the data line DT2 to the high level during the time when the CAM 20 receives the address HAD “0400h” from the stack processing unit 10.

FIG. 7 illustrates an example of the RAM 40 illustrated in FIG. 2. The RAM 40 includes multiple memory cells MC that are each connected to any of 512 word lines WL (WL0 to WL511) and any of 32 bit lines BL (BL0 to BL31). Storage nodes of memory cells MC connected to a word line WL of the high level are connected to the bit lines BL, while storage nodes of memory cells MC connected to a word line WL of the low level are not connected to the bit lines BL. The memory cells MC connected to the word lines WL are an example of accumulation regions corresponding to the storage regions of the CAM 20. The RAM 40 also includes write amplifiers WA connected to the bit lines BL0 to BL31, read amplifiers RA connected to the bit lines BL0 to BL31, and a control circuit CNTL that controls operations of the write amplifiers WA and operations of the read amplifiers RA.

The control circuit CNTL outputs a write control signal WR when receiving the high-level task run signal TRUN by a chip select terminal CS and receiving a low-level signal by a write enable terminal/WE. In addition, the control circuit CNTL outputs a read control signal RD when receiving the high-level task run signal TRUN by the chip select terminal CS and receiving a high-level signal by the write enable terminal/WE. Any of the write enable signals DWE and EWE is supplied to the write enable terminal/WE. The control circuit CNTL includes a circuit that avoids overlapping of a time period for which the write control signal WR is at the high level with a time period for which the read control signal RD is at the high level.

The write amplifiers WA amplify signal amounts of data received by the data input terminals DI (DI0 to DI31) based on the write control signal WR and output the amplified data to the bit lines BL (BL0 to BL31). The read amplifiers RA amplify signal amounts of data on the bit lines BL (BL0 to BL31) based on the read control signal RD and output the amplified data to the data output terminals DO (DO0 to DO31).

FIG. 8 illustrates an example of operations of the program profiler circuit 300A illustrated in FIG. 2 in the evaluation mode and the measurement mode. Steps S10, S20, S30, S60, and S70 indicate operations in the evaluation mode, while steps S40 and S50 indicate operations in the measurement mode.

First, in step S10, the CPU 200A causes the processor 100A to generate the control signal CAMWR and registers the head addresses of the subroutines of the program to be evaluated in the CAM 20. The head addresses to be registered in the CAM 20 are generated at a stage of compiling the program to be evaluated, coupling the program to be evaluated to a load module by a linker, and loading the program to be evaluated in a memory by a loader. FIG. 6 illustrates an example of the state of the CAM 20 in which the head addresses of the subroutines A, B, and C are registered in the case where the program to be evaluated includes the three subroutines A, B, and C illustrated in FIG. 5.

Next, in step S20, the CPU 200A causes the processor 100A to generate the address EAD, the write enable signal EWE, the chip select signal ECS, and the data input signal EDI and causes the RAM 40 to execute the writing operation. Then, the CPU 200A writes “0” in all the memory cells MC of the RAM 40. By steps S10 and S20, the program profiler circuit 300A is initialized.

Next, in step S30, the CPU 200A causes the processor 100A to assert the task run signal TRUN and thereby causes the program profiler circuit 300A to transition from the evaluation mode to the measurement mode.

Next, in step S40, the CPU 200A starts to execute the program to be evaluated. After the execution of the program to be evaluated is terminated, the CPU 200A causes the processor 100A to negate the task run signal TRUN and causes the program profiler circuit 300A to transition from the measurement mode to the evaluation mode in step S50.

Next, in step S60, the CPU 200A causes the processor 100A to generate the address EAD, the write enable signal EWE, and the chip select signal ECS and causes the RAM 40 to execute the reading operation. Then, the CPU 200A reads, from the RAM 40, the data output signal EDO indicating the numbers of execution cycles of the subroutines A, B, and C included in the program to be evaluated.

Next, in step S70, the CPU 200A calculates products of the cycle of the divided clock DCLK and the numbers, read from the RAM 40, of the execution cycles of the subroutines A, B, and C. The calculated products indicate the execution times of the subroutines A, B, and C. The CPU 200A outputs the calculated products. Then, a person who designed the program to be evaluated or the like checks the validity of the execution times, indicated by the calculated products, of the subroutines A, B, and C.

FIGS. 9 and 10 illustrate an example of operations of the program profiler circuit 300A illustrated in FIG. 2 in the measurement mode. FIG. 10 illustrates operations continued from operations illustrated in FIG. 9. FIGS. 9 and 10 illustrate the operations executed in step S40 illustrated in FIG. 8. In FIG. 9, the numbers of execution cycles of the subroutines A and B included in the program illustrated in FIG. 5 and to be evaluated are measured. In FIG. 10, the number of execution cycles of the subroutine C included in the program illustrated in FIG. 5 and to be evaluated is measured. In the example illustrated in FIGS. 9 and 10, a division ratio of the divided clock DCLK to the clock CLK is “4”. The division ratio, however, is not limited to “4”. As described above, it is sufficient if the frequency of the divided clock DCLK is a frequency that enables the reading operation and writing operation of the RAM 40 to be executed within one cycle of the divided clock DCLK.

The divided clock DCLK is output regardless of a logical value of the mode signal EMD ((a) illustrated in FIG. 9). The instruction decoder DEC of the CPU 200A decodes the instruction JSR(A) and outputs the call information JSR(A) ((b) illustrated in FIG. 9). Specifically, the program illustrated in FIG. 5 and to be evaluated calls the subroutine A from the main routine. The OR circuit OR1 illustrated in FIG. 2 responds to the call information JSR(A) and outputs the enable signal EN ((c) in FIG. 9).

The stack processing unit 10 illustrated in FIG. 4 executes the stacking operation based on the enable signal EN and the low-level restoration information RTS. Specifically, the stack processing unit 10 latches the address CAD (“0200h”) in the flip-flop FF1 and causes the value latched in the flip-flop FF1 to be output from the flip-flop FF1 as the address HAD ((d) illustrated in FIG. 9). The address HAD is latched by the flip-flop 11 (D-FF) operating in synchronization with the divided clock DCLK and is output as the address HADd to the CAM 20. The flip-flop 11 is installed to synchronize the stack processing unit 10 operating based on the clock CLK with circuits installed on the downstream side of the CAM 20 operating based on the divided clock DCLK obtained by dividing the clock CLK. Before the instruction decoder DEC decodes the instruction JSR(A), all the flip-flops FF of the stack processing unit 10 maintain the initial values “0” and output addresses HAD indicating “0”. In this case, the values of the addresses HAD do not match the data held by the CAM 20, and thus the RAM 40 is not accessed.

The CPU 200A sequentially increments a value of the program counter PC and executes the subroutine A ((e) illustrated in FIG. 9). The CAM 20 searches a storage region storing the same value (“0200h”) as the address HAD and asserts, to the high level, the data line DT0 corresponding to the storage region storing the value “0200h” ((f) illustrated in FIG. 9). The values of the addresses HAD output from the stack processing unit 10 are maintained until the call information JSR or the restoration information RTS is output. The high level of the data line DT0 is maintained for a predetermined time period after the call information JSR or the restoration information RTS is output. For example, it is assumed that an access time from the time when the CAM 20 receives a change in the address HADd to the time when the CAM 20 asserts the data line DT0 corresponds to approximately 2.5 cycles of the clock CLK.

Since the logical value of the mode signal EMD is “0” (or indicates the measurement mode), the selector 30 illustrated in FIG. 2 transmits the levels of the data lines DT of the CAM 20 to the word lines WL of the RAM 40. Thus, the word line WL0 changes to the high level together with the change of the data line DT0 to the high level. The other word lines WL1 to WL511 are maintained at the low level “L”.

The memory controller 80 generates, in synchronization with the divided clock DCLK, the write enable signal DWE delayed by a predetermined time and having a predetermined pulse width ((g) illustrated in FIG. 9). In addition, the memory controller 80 outputs the clock RCLK synchronized with the divided clock DCLK when the output of the RAM 40 is able to be latched by the register 50 ((h) illustrated in FIG. 9).

The flip-flop 11 latches the address HAD in synchronization with the divided clock DCLK obtained by dividing the frequency of the clock CLK to be used to cause the CPU 200A to operate and generates the address HADd in synchronization with the divided clock DCLK. Thus, the memory controller 80 may sequentially generate, in synchronization with the divided clock DCLK, a read request and a write request that are each indicated by the write enable signal DWE. The timing of outputting the write enable signal /WE (read request) to be supplied to the RAM 40 may match the timing of changing a word line WL to the high level based on the address HADd. Since the memory controller 80 generates the clock RCLK synchronized with the divided clock DCLK, the register 50 may latch the output of the RAM 40 after a certain time after the supply of the read request. As a result, the reading operation and the writing operation may be accurately executed by the RAM 40.

The memory controller 80 may generate the high-level write enable signal DWE based on falling edges of the divided clock DCLK and generate the low-level write enable signal DWE based on rising edges of the divided clock DCLK. In this case, the memory controller 80 sequentially generates the high-level write enable signal DWE (read request) and the low-level write enable signal DWE (write request) upon the assertion of the data line DT0.

In the example illustrated in FIG. 9, since the logical level of the mode signal EMD is “0” (measurement mode), the switch SW2 illustrated in FIG. 2 selects the write enable signal DWE and transfers the selected write enable signal DWE to the write enable terminal/WE of the RAM 40. The task run signal TRUN with a logical level “1” is supplied to the chip select terminal CS of the RAM 40 and the RAM 40 becomes an active state. Then, the RAM 40 executes the reading operation or the writing operation based on the logical level received by the write enable terminal/WE.

The control circuit CNTL of the RAM 40 illustrated in FIG. 7 asserts the read control signal RD in synchronization with rising edges of the write enable signal DWE synchronized with the divided clock DCLK and executes the reading operation ((i) illustrated in FIG. 9). In the reading operation, the data “0” is read into the bit lines BL0 to BL63 from the memory cells MC connected to the high-level word line WL0 and is output as a data output signal DO ((j) illustrated in FIG. 9). The register 50 latches the data output from the RAM 40 in synchronization with the clock RCLK and outputs the latched data to the incrementer 60. The incrementer 60 outputs data obtained by adding “1” to the data received from the register 50 to the data input terminals DI of the RAM 40 through the switch SW1.

The RAM 40 asserts the write control signal WR in synchronization with the falling edges of the divided clock DCLK and executes the writing operation ((k) illustrated in FIG. 9). In the writing operation, the data received by the data input terminals DI from the incrementer 60 is written in the memory cells MC connected to the high-level word line WL0 through the bit lines BL0 to BL63 ((l) illustrated in FIG. 9). For example, the sum of a time period for which the RAM 40 executes the reading operation and the writing operation and a time period from the time when the register 50 receives the data to the time when the incrementer 60 outputs the data with the increased value is equal to or shorter than one cycle of the divided clock DCLK.

After that, the memory controller 80 repeatedly generates the write enable signal DWE and the control circuit CNTL of the RAM 40 alternately generates the read control signal RD and the write control signal WR based on the write enable signal DWE. Then, the reading operation and the writing operation are alternately executed, and the data stored in the memory cells MC connected to the word line WL0 is increased by 1. In the example illustrated in FIG. 9, since the data line DT0 is changed to the low level after the termination of the writing operation and before the start of the reading operation, a value “5” is maintained in the RAM 40 based on the execution of the subroutine A ((m) illustrated in FIG. 9).

The instruction decoder DEC of the CPU 200A outputs the call information JSR(C) based on the decoding of the instruction JSR(C) ((n) illustrated in FIG. 9) and the OR circuit OR1 responds to the call information JSR(C) and outputs the enable signal EN ((o) illustrated in FIG. 9). Specifically, the program illustrated in FIG. 5 and to be evaluated calls the subroutine C from the subroutine A. The stack processing unit 10 executes the stacking operation based on the enable signal EN and the low-level restoration information RTS. Specifically, the stack processing unit 10 transfers the address CAD (“0200h”) held by the flip-flop FF1 illustrated in FIG. 4 to the flip-flop FF2 and latches the address CAD (“0400h”) in the flip-flop FF1. Then, the stack processing unit 10 outputs the value latched in the flip-flop FF1 as the address HAD ((p) illustrated in FIG. 9).

The CAM 20 asserts, to the high level, the data line DT2 corresponding to a storage region storing the same value (“0400h”) as the address HAD and negates the data line DT0 to the low level ((q) and (r) illustrated in FIG. 9). The levels of the data lines DT2 and DT0 of the CAM 20 are transmitted to the word lines WL2 and WL0 of the RAM 40, the word line WL2 is changed to the high level, and the word line WL0 is changed to the low level. After that, the program profiler circuit 300A operates in the same manner as the operations executed upon the execution of the subroutine A and causes the RAM 40 to alternately execute the reading operation and the writing operation during the time when the data line DT2 is asserted ((s) illustrated in FIG. 9). Then, data stored in the memory cells MC connected to the word line WL2 is increased by 1.

The instruction decoder DEC of the CPU 200A outputs the restoration information RTS(C) based on the decoding of the instruction RTS(C) ((t) illustrated in FIG. 9) and the OR circuit OR1 responds to the restoration information RTS(C) and outputs the enable signal EN ((u) illustrated in FIG. 9). Specifically, the program illustrated in FIG. 5 and to be evaluated returns from the subroutine C to the subroutine A.

The stack processing unit 10 executes the unstacking operation based on the enable signal EN and the high-level restoration information RTS and transfers the value (“0200h”) of the address CAD held by the flip-flop FF2 illustrated in FIG. 4 to the flip-flop FF1. Then, the stack processing unit 10 outputs the address HAD (“0200h”) ((v) illustrated in FIG. 9).

After that, the program profiler circuit 300A operates in the same manner as the operations executed upon the execution of the subroutine A and alternately executes the reading operation and the writing operation on the memory cells MC connected to the word line WL0 corresponding to the data line DT0 of the RAM 40 ((w) illustrated in FIG. 9). Then, the data stored in the memory cells MC connected to the word line WL0 is increased by 1. In this case, by matching the timing of a data signal DT to be output from the CAM 20 to the data line DT0 with a time period for which the write enable signal DWE is at the high level, the reading operation of the RAM 40 may start before the writing operation during the assertion of the word line WL0. As a result, values previously held by the RAM 40 may be sequentially increased and the writing of an erroneous value in the RAM 40 may be suppressed. If the writing operation is executed before the reading operation, the value “3” corresponding to the subroutine B and output from the incrementer 60 may be written over the value corresponding to the subroutine A and held by the RAM 40.

The instruction decoder DEC of the CPU 200A outputs the restoration information RTS(A) based on the decoding of the instruction RTS(A) ((x) illustrated in FIG. 9) and the OR circuit OR1 responds to the restoration information RTS(A) and outputs the enable signal EN ((y) illustrated in FIG. 9). Specifically, the program illustrated in FIG. 5 and to be evaluated returns to the main routine from the subroutine A. The stack processing unit 10 executes the unstacking operation based on the enable signal EN and the high-level restoration information RTS, transfers the initial value “0” held by the flip-flop FF2 illustrated in FIG. 4 to the flip-flop FF1, and outputs the initial value “0” as the address HAD. During the time when the CPU 200A executes the main routine, the address HAD is maintained at “0” and does not match the data held by the CAM 20. Thus, the RAM 40 is not accessed and maintains values accumulated in the RAM 40.

Next, the instruction decoder DEC of the CPU 200A outputs the call information JSR(B) based on the decoding of the instruction JSR(B) ((a) illustrated in FIG. 10). The OR circuit OR1 responds to the call information JSR(B) and outputs the enable signal EN ((b) illustrated in FIG. 10). Specifically, the program illustrated in FIG. 5 and to be evaluated calls the subroutine B from the main routine. The stack processing unit 10 executes the stacking operation based on the enable signal EN and the low-level restoration information RTS. Specifically, the stack processing unit 10 latches the address CAD (“0300h”) in the flip-flop FF1 and outputs the value latched in the flip-flop FF1 as the address HAD ((c) illustrated in FIG. 10).

The CAM 20 asserts, to the high level, the data line DT1 corresponding to a storage region storing the same value (“0300h”) as the address HAD ((d) illustrated in FIG. 10). The levels of the data lines DT of the CAM 20 are transmitted to the word lines WL of the RAM 40, and the word line WL1 is changed to the high level. After that, the program profiler circuit 300A operates in the same manner as the operations executed upon the execution of the subroutine A and causes the RAM 40 to alternately execute the reading operation and the writing operation during the time when the data line DT1 is asserted ((e) illustrated in FIG. 10). Then, data stored in the memory cells MC connected to the word line WL1 is increased by 1.

The instruction decoder DEC of the CPU 200A outputs the restoration information RTS(B) based on the decoding of the instruction RTS(B) ((f) illustrated in FIG. 10) and the OR circuit OR1 responds to the restoration information RTS(B) and outputs the enable signal EN ((g) illustrated in FIG. 10). Specifically, the program illustrated in FIG. 5 and to be evaluated returns to the main routine from the subroutine B.

The stack processing unit 10 executes the unstacking operation based on the enable signal EN and the high-level restoration information RTS, transfers the initial value “0” held by the flip-flop FF2 illustrated in FIG. 4 to the flip-flop FF1, and outputs the initial value “0” as the address HAD.

By the aforementioned operations, “7” is held by memory cells MC corresponding to the subroutine A and “5” is held by memory cells MC corresponding to the subroutine B in the RAM 40 after the execution of the program to be evaluated. In addition, “3” is held by memory cells MC corresponding to the subroutine C. In the actual program, the numbers of execution cycles of the subroutines A, B, and C are larger than the numbers of cycles that are illustrated in FIGS. 9 and 10. The RAM 40 may hold up to cycles of the “32nd power of 2” for each subroutine.

In the second embodiment illustrated in FIGS. 2 to 10, effects that are the same as or similar to those described in the first embodiment illustrated in FIG. 1 may be obtained. Specifically, by stacking the head addresses in the stack processing unit 10 based on the call information JSR, the numbers of execution cycles of the subroutines may be accumulated in the RAM 40 without an increase in a storage capacity of the CAM 20 that identifies a subroutine that is being executed. As a result, execution times of the subroutines included in the program may be measured regardless of the size of the program.

In the second embodiment illustrated in FIGS. 2 to 10, the read request and the write request are sequentially supplied to the RAM 40 during the assertion of a word line signal WL, and a process of rewriting, in the RAM 40, values obtained by incrementing data read from the RAM 40 by the incrementer 60 is repeated. Thus, the RAM 40 may operate as a counter, and values that indicate execution times of the subroutines may be held by the RAM 40.

The memory controller 80 generates the read request indicated by the write enable signal DWE in synchronization with the divided clock DCLK and the flip-flop 11 latches the address HAD in synchronization with the divided clock DCLK and generates the address HADd to be supplied to the CAM 20. Thus, the timing of the read request may match the timing of changing a word line WL to the high level. As a result, the supply of the read request to the RAM 40 before the change of the word line WL to the high level may be suppressed and an erroneous operation of the RAM 40 may be suppressed.

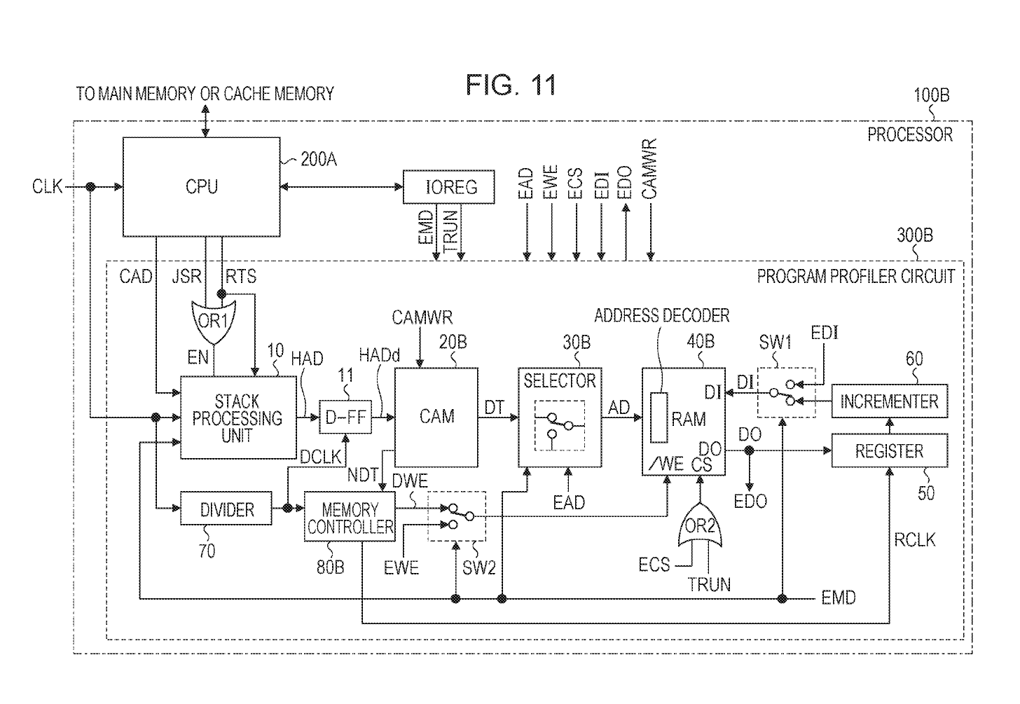

FIG. 11 illustrates a third embodiment of the program profiler circuit, the processor, and the program counting method. Elements that are the same as or similar to those described in the second embodiment illustrated in FIG. 2 are indicated by the same reference numbers and symbols and a detailed description of the elements is omitted. A processor 100B according to the third embodiment includes a profiler circuit 300B, instead of the program profiler circuit 300A illustrated in FIG. 2. The profiler circuit 300B includes a CAM 20B, a selector 30B, a RAM 40B, and a memory controller 80B, instead of the CAM 20, the selector 30, the RAM 40, and the memory controller 80 that are illustrated in FIG. 2. Operations of the profiler circuit 300B illustrated in FIG. 11 are the same as or similar to those described with reference to FIGS. 8 to 10.

The CAM 20B is different from the CAM 20 illustrated in FIG. 2 in a feature in which the CAM 20B outputs, to a common data line DT, data indicating a storage region holding a value of the address HADd received from the stack processing unit 10 through the flip-flop 11. Information that is the same as or similar to the information illustrated in FIG. 6 is written in the CAM 20B. When receiving the address HADd (“0200h”), the CAM 20B outputs data DT indicating “0”. When receiving the address HADd (“0300h”), the CAM 20B outputs data DT indicating “1”. When receiving the address HADd (“0400h”), the CAM 20B outputs data DT indicating “2”. Specifically, the CAM 20B has a configuration obtained by adding an encoder to the CAM 20 illustrated in FIG. 2. If a value of the address HADd is not registered in any of storage regions of the CAM 20B, the CAM 20B asserts a signal NDT indicating that the address HADd does not match any of addresses stored in the storage regions, and the CAM 20B outputs the signal NDT to the memory controller 80B. The memory controller 80B negates the write enable signal DWE and inhibits the RAM 40B from executing the writing operation during the time when the signal NDT is asserted. Data is registered in the CAM 20B based on the control signal CAMWR by the evaluation program executed by the CPU 200A.

The selector 30B transmits the address EAD as an address AD to the RAM 40B during the assertion of the mode signal EMD (evaluation mode). In addition, the selector 30B transmits a data signal DT received from the CAM 20B as the address AD to the RAM 40B during the negation of the mode signal EMD (measurement mode).

The RAM 40B has an address decoder corresponding to the decoder 90 illustrated in FIG. 2. The address decoder decodes the address AD supplied from the selector 30B and sets a word line WL (illustrated in FIG. 7) indicated by the address AD to the high level. Specifically, the RAM 40B has the same input and output interface as that included in a general-purpose SRAM or the like. The RAM 40B has the same configuration as the RAM 40 illustrated in FIG. 7, except for the address decoder.

In the third embodiment illustrated in FIG. 11, execution times of the subroutines included in the program may be measured regardless of the size of the program in a manner that is the same as or similar to that described in the embodiments illustrated in FIGS. 1 to 10. In the third embodiment illustrated in FIG. 11, the program profiler circuit 300B may be built using a general-purpose RAM

The characteristic points and advantages of the embodiments will be clarified from the above description. This indicates that the claims include the characteristic points and advantages of the aforementioned embodiments without departing from the spirit and scope of the claims. In addition, persons who have common knowledge in the art may easily conceive various modifications and changes. Thus, it is not intended that the scope of the inventive embodiments is limited to the above description. The embodiments may be based on appropriate modifications and equivalents included in the scope disclosed in the embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A program profiler circuit comprising:
a stack processing unit having a first storage region and configured to stack, in the first storage region based on the fact that an instruction to call a subroutine is detected by an arithmetic processing device, a head address, output from the arithmetic processing device, of the subroutine and to unstack a lastly stacked head address from the first storage region based on the fact that a restoration instruction to return to a source from which the subroutine is called is detected by the arithmetic processing device;
a matching determining unit that has a plurality of second storage regions in which head addresses of subroutines are registered and is configured to output region information indicating a second storage region having registered therein a head address that is any of the head addresses registered in the plurality of second storage regions and matches the head address lastly stacked by the stack processing unit; and
an accumulator that has a plurality of accumulation regions corresponding to the plurality of second storage regions and is configured to repeat a process of adding a predetermined value to a value stored in an accumulation region corresponding to the region information during the output of the region information from the matching determining unit.

2. The program profiler circuit according to claim 1, further comprising
a controller configured to repeatedly output a read request and a write request to the accumulator during the output of the region information from the matching determining unit,
wherein the accumulator includes
a storage unit that has the plurality of accumulation regions and from which a first value held in the accumulation region corresponding to the region information is read based on the read request and in which a second value is written in the accumulation region corresponding to the region information based on the write request,
a holder configured to hold the first value read from the storage unit, and
an adder configured to add the predetermined value to the first value held by the holder and output the second value obtained by the addition to the storage unit.

3. The program profiler circuit according to claim 2,
wherein the controller outputs the read request in synchronization with rising edges or falling edges of a first clock and outputs the write request in synchronization with the other edges of the first clock after the output of the read request during the output of the region information from the matching determining unit.

4. The program profiler circuit according to claim 3, further comprising
a divider that is configured to divide the frequency of a second clock to be used to cause the arithmetic processing device to operate and is configured to generate the first clock.

5. A processor comprising:
an arithmetic processing device configured to execute a program; and
a program profiler circuit configured to measure an execution time of a subroutine executed by the arithmetic processing device,
wherein the program profiler circuit includes
a stack processing unit having a first storage region and configured to stack, in the first storage region based on the fact that an instruction to call the subroutine is detected by the arithmetic processing device, a head address, output from the arithmetic processing device, of the subroutine and to unstack a lastly stacked head address from the first storage region based on the fact that a restoration instruction to return to a source from which the subroutine is called is detected by the arithmetic processing device;
a matching determining unit that has a plurality of second storage regions in which head addresses of subroutines are registered and is configured to output region information indicating a second storage region having registered therein a head address that is any of the head addresses registered in the plurality of second storage regions and matches the head address lastly stacked by the stack processing unit; and
an accumulator that has a plurality of accumulation regions corresponding to the plurality of second storage regions and is configured to repeat a process of adding a predetermined value to a value stored in an accumulation region corresponding to the region information during the output of the region information from the matching determining unit.

6. The processor according to claim 5,
wherein the arithmetic processing device includes
an operating unit configured to execute calculation,
an instruction decoder configured to decode an instruction, output call information if the decoded instruction indicates the call instruction, and output restoration information if the decoded instruction indicates the restoration instruction,
a program counter configured to output an address indicating a region storing the instruction decoded by the instruction decoder,
an incrementer configured to increment the address output from the program counter, and
a selector configured to select the address output from the incrementer or an address output from the operating unit and output the selected address to the program counter, and
wherein the stack processing unit stacks, in the first storage region based on the call information, the address output from the operating unit to the selector as the head address and unstacks the lastly stacked head address from the first storage region based on the restoration information.

7. A program counting method comprising:
causing a stack processing unit installed in a program profiler circuit to stack, in a first storage region based on the fact an instruction to call a subroutine is detected by an arithmetic processing device, a head address, output from the arithmetic processing device, of the subroutine;
causing the stack processing unit to unstack a lastly stacked head address from the first storage region based on the fact that a restoration instruction to return to a source from which the subroutine is called is detected by the arithmetic processing device;
causing a matching determining unit installed in the program profiler circuit to output region information indicating a second storage region having registered therein a head address that is any of head addresses registered in a plurality of second storage regions and matches the head address lastly stacked by the stack processing unit; and
causing an accumulator installed in the program profiler circuit to repeat a process of adding a predetermined value to a value stored in an accumulation region corresponding to the region information during the output of the region information from the matching determining unit.
